(19) United States
(12) Patent Application Publication
(10) Pub. No.: US 2005/0018376 A1
(43) Pub. Date: Jan. 27, 2005

(54) Electrostatic chuck for wafer

(75) Inventors: Jong-rok Park, Suwon city (KR); Jae-yong Cho, Daegu City (KR); Byeong-sun An, Suwon city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/820,863

(22) Filed: Apr. 9, 2004

(30) Foreign Application Priority Data
Jul. 23, 2003 (KR) 2003-50448

(51) Int. Cl. H01H 1/00

(52) U.S. Cl. 361/234

(57) ABSTRACT

An electrostatic chuck (ESC) for a wafer which directs a cooling gas to predetermined cooling areas of the wafer mounted on the chuck. Ring type sealing members divide the mounted wafer into the predetermined cooling areas and the predetermined cooling areas are independently supplied with a helium cooling gas. Each of the predetermined cooling areas is supplied through a separate conduit system wherein each conduit system has a single inlet into the chuck and a plurality of outlets which emit the helium gas into a respective one of the predetermined cooling areas. The plurality of outlets for each predetermined cooling area may communicate with the inlet via a respective plurality of branch conduits or via one or more branch conduits and a peripheral conduit which connects the plurality of outlets. By independently controlling the predetermined cooling areas, temperature variations on the wafer are effectively controlled.

### CROSS-REFERENCE TO RELATED APPLICATIONS

This application claims the benefit of Korean Patent Application No. 2003-50448, filed Jul. 23, 2003 in the Korean Intellectual Property Office, the disclosure of which is incorporated herein by reference.

### BACKGROUND OF THE INVENTION

1. Field of the Invention

The present invention relates to an electrostatic chuck (ESC) for a wafer, and more particularly to an ESC for a wafer which reduces heat generated in the wafer by supplying a helium gas through a helium supply passage simply and conveniently.

2. Description of the Related Art

In general, a manufacturing process for a wafer as a kind of semiconductor element proceeds inside a chamber which is a sealed reaction container, and an ESC which retains the wafer using an electrostatic interaction is installed inside of the chamber.

The ESC is widely used in an etching device, or a chemical vapor deposition device, and especially for controlling a temperature of the wafer installed in the ESC in a semiconductor manufacturing process. The temperature of the wafer seriously affects completed semiconductor element aspects such as uniformity, profile, repeatability and the like. Therefore, the ESC continuously cools the wafer using the helium gas to prevent the wafer from being destroyed because of a high temperature generated during wafer processing.

As shown in FIG. 1, FIG. 2A and FIG. 2B, a conventional ESC for a wafer comprises a base 2 in which a wafer 7 is mounted; a center hole 3 provided in a center of the base 2, and emitting a helium gas to a center part 7a of the wafer 7; a plurality of edge holes 4 formed at an outer side of the base 2 and emitting the helium gas to an edge part 7b of the wafer 7; an inner circular hole 5 connecting the plurality of edge holes 4 with each other; and a radial shaped connection hole 6 connecting the center hole 3 and the edge holes 4.

The ESC 1 increases a most outside height difference d of the base 2 to increase a volume in which the helium gas is filled, thereby maintaining a temperature distribution in the edge part 7b and the center part 7a of the wafer 7 uniformly, and decreases the width of the center hole 3 to be small compared with a width of each edge hole 4, thereby increasing the amount of the helium gas emitted through the edge holes 4 to uniformly cool down the center part 7a and the edge part 7b of the wafer 7.

However, the conventional ESC 1 for a wafer has a problem of distributing the helium gas unevenly because a mounted condition and a process tolerance of the wafer 7 cause a leakage of the helium gas and the helium gas is supplied to the center part 7a and the edge part 7b of the wafer 7 asynchronously. Also, the amount of the helium gas flowing into the wafer 7 through the center hole 3 is not enough to prevent a temperature of the edge part 7b from being increased.

It is difficult to make an overall temperature in the wafer 7 uniform using the most outside height difference d of the ESC 1, and increasing the size of the edge hole 4 to supply a massive amount of the helium gas to the edge part 7b of the wafer 7 may cause arching by plasma generated during the process, thereby shortening a lifecycle of the ESC 1.

Recently, an ESC (Electrostatic Chuck) designed to cool down a center part and an edge part of a wafer using an independent helium gas supply hole considering the above problem is disclosed Japanese Patent First Publication No. 2002-305238, and Japanese Patent First Publication No. 1989-251735, but the ESC of the publications has a complicated structure for supplying the helium gas, thereby reducing ESC productivity and an efficiency of cooling.

### SUMMARY OF THE INVENTION

Accordingly, an aspect of the present invention is to provide an electrostatic chuck (ESC) which decreases a temperature difference between an edge part and a center part of a wafer to improve an efficiency of cooling.

Additional aspects and/or advantages of the invention will be set forth in part in the description which follows and, in part, will be obvious from the description, or may be learned by practice of the invention.

The foregoing and/or other aspects of the present invention are achieved by providing an ESC for a wafer comprising a base on which the wafer is mounted; a ring-type first sealing member provided in an upper end part of the base; a ring-type second sealing member separately provided inside the first sealing member and in an upper side of the base, and dividing the wafer into an edge part and a center part when the wafer is mounted; a first helium supply passage formed branched inside the base, and emitting a helium gas to the edge part of the wafer; and a second helium supply passage provided inside the base having a difference with the first helium supply passage in height, and emitting the helium gas to the center part of the wafer.

According to an aspect of the present invention, the first helium gas supply passage comprises a first helium inlet provided in a bottom center of the base; a plurality of first helium gas outlets provided in an outer upper part of the base corresponding to the edge part of the wafer; and a first inner conduit formed branched from the first helium gas inlet, and connected to the first helium gas outlet.

According to an aspect of the present invention, the first inner conduit comprises a plurality of first branch conduit connected to the first helium gas inlet; and a first circular conduit connected to the first branch conduit and the first helium gas outlet.

According to an aspect of the present invention, the second helium gas supply passage comprises a second helium inlet provided in a bottom center of the base; a plurality of second helium gas outlets provided in an upper part of the base corresponding to the center part of the wafer; and a second inner conduit formed branched from the second helium gas inlet, and connected to the second helium gas outlet.

According to an aspect of the present invention, the second inner conduit comprises a plurality of second branch conduits connected to the second helium gas inlet; and a second circular conduit connected to the second branch conduit and the second helium outlet.

According to another aspect of the present invention, the forgoing and other aspects may be also achieved by providing the ESC, further comprising a ring typed third sealing member separated into from the second inner conduit and provided in the upper side of the base, and dividing the center part of the wafer when the wafer is mounted; and a third helium gas supply passage provided inside of the base having a difference with the second helium gas supply conduit in height, and emitting the helium gas to the divided center part of the wafer respectively.

According to an aspect of the present invention, the third helium gas supply passage comprises a third helium gas inlet provided in a bottom center of the base; a plurality of third helium gas outlets provided in an upper part of the base corresponding to the divided center part respectively; and a third inner conduit formed branched from the third helium gas inlet having a difference with the second inner conduit in height, and connected to the third helium gas outlet.

According to an aspect of the present invention, the third inner conduit comprises a plurality of third branch conduits connected to the third helium gas inlet; and a third circular conduit connected to the third branch conduit and the third helium gas outlet.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a bottom view of a conventional electrostatic chuck (ESC) for a wafer;

FIG. 2A is a sectional view of a conventional ESC for a wafer in use;

FIG. 2B is an enlarged view of a portion of FIG. 2A;

FIG. 3 is a top view of an ESC for a wafer according to a first embodiment of the present invention;

FIG. 4 is a bottom view illustrating a helium gas supply hole of the ESC for a wafer according to the first embodiment in the present invention;

FIG. 5 is a sectional view for illustrating the ESC for a wafer in use according to the first embodiment of the present invention;

FIG. 6 is a top view of an ESC for a wafer according to a second embodiment of the present invention;

FIG. 7 is a bottom view illustrating a helium gas supply hole of the ESC for a wafer according to the second embodiment of the present invention; and

FIG. 8 is a sectional view for illustrating the ESC for a wafer in use according to the second embodiment of the present invention.

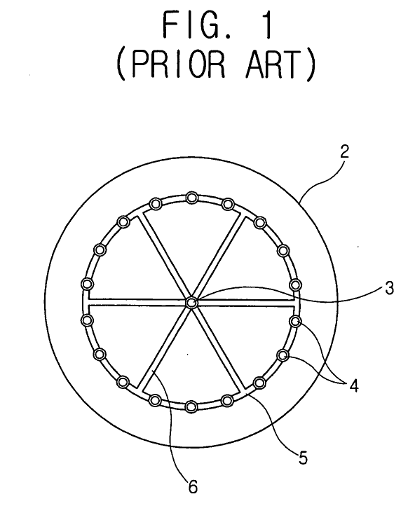

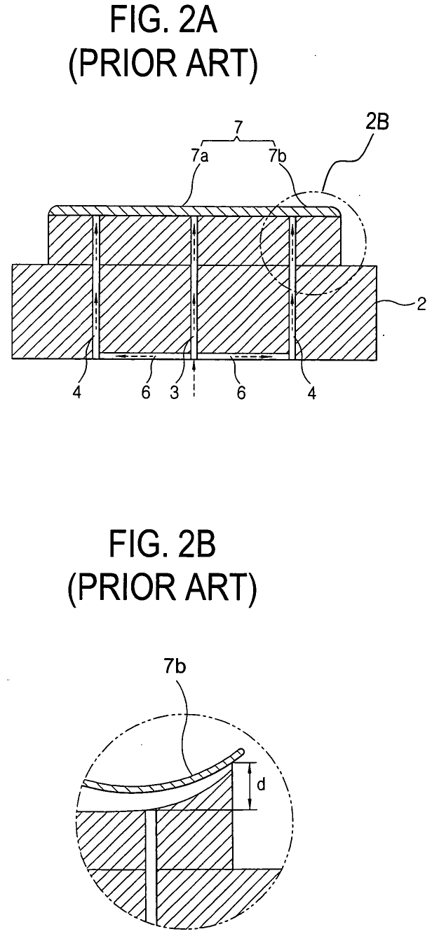

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

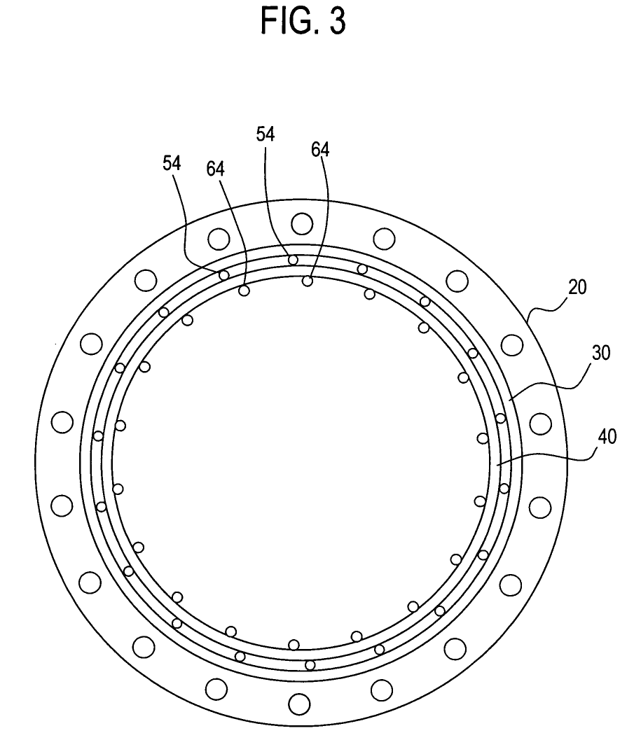

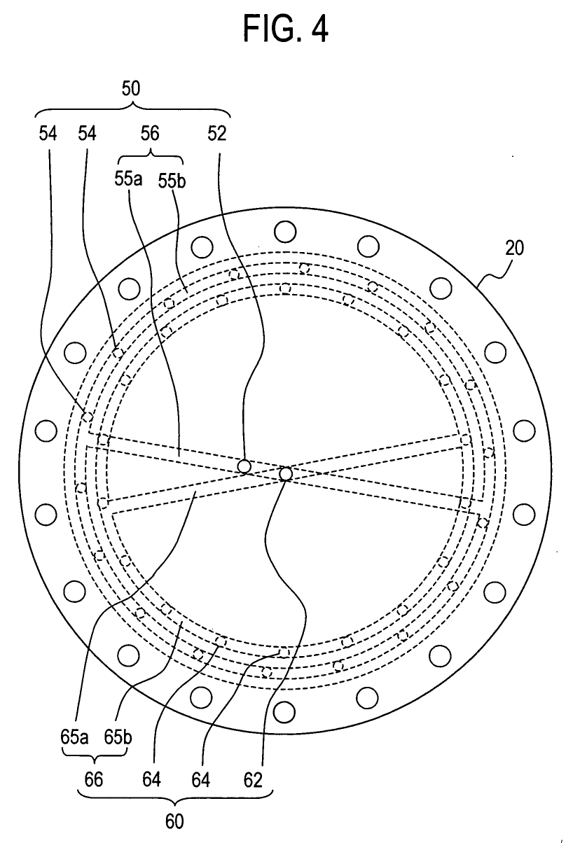

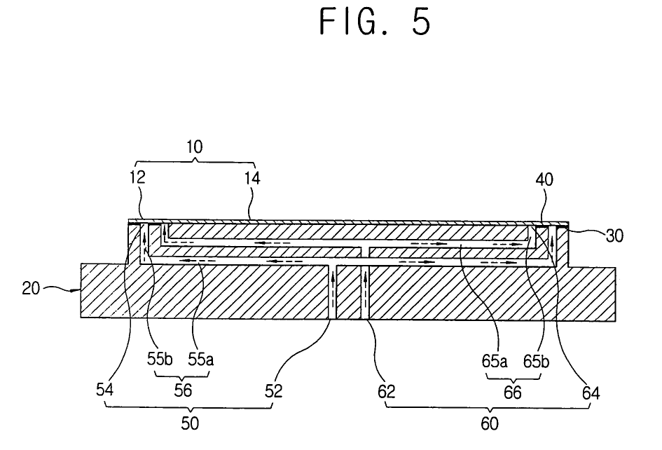

FIG. 3 is a top view of an electrostatic chuck (ESC) for a wafer according to a first embodiment of the present invention, FIG. 4 is a bottom view illustrating helium gas supply passages of the ESC for a wafer according to the first embodiment in the present invention, and FIG. 5 is a sectional of view for illustrating the ESC for a wafer in use according to the first embodiment of the present invention. As shown in FIGS. 3, 4 and 5, the ESC for a wafer according to the present invention comprises a base 20 on which a wafer 10 is mountable; a first ring shaped sealing member 30 provided on an outer portion of an upper end of the base 20; a second ring shaped sealing member 40 provided on the upper end of the base 20 to separate an inner portion of the upper end from the first sealing member 30, and dividing the wafer 10 into an edge part 12 and a center part 14 when the wafer 10 is mounted on the ESC; a first helium supply passage 50 formed branched in the base 20, and to emit a helium gas to the edge part 12 of the water 10; and a second helium supply passage 60 formed branched in the base 20 to emit the helium gas to the center part 14 of the water 10.

The wafer 10 is fixed by an electrostatic interaction between an electrostatic field generated by applying direct current voltage to the base 20 and the wafer 10, and a size and a shape of the base 20 can be variously changed if required.

The first sealing member 30 and the second sealing member 40 are circular, and restrict a flow of the helium gas respectively supplied to the edge part 12 and the center part 14 of the wafer 10.

The first helium supply passage 50 comprises a first helium gas inlet 52 provided in a bottom center of the base 20; a plurality of helium gas outlets 54 provided in an outer upper part of the base 20 corresponding to the edge part 12 of the wafer 10, and to emit the helium gas to the edge part 12 of the wafer 10; and a first inner conduit 56 formed branched from the first helium gas inlet 52 and connected to the first helium gas outlets 54.

The first helium gas inlet 52 may be selectively provided at a convenient location in a bottom part of the base 20, but preferably provided in a bottom center of the base 20 to enhance a cooling efficiency of the wafer 10 having the helium gas supplied to the edge part 12 and the center part 14 of the wafer 10 synchronously.

The plurality of first helium gas outlets 54 are provided along an outer circumference of the base 20 at regular intervals to emit the helium gas corresponding to the edge part 12 of the wafer 10.

The first inner conduit 56 may comprise a plurality of first branch conduits 55a (one of which is shown) connected to the first helium gas inlet 52, and a first circular conduit 55b connected to the first branch conduits 55a and the first helium gas outlets 54. Alternatively, the first inner conduit 56 may be formed by omitting the first circular conduit 55b, making a number of the first branch conduits 55a and a number of first helium gas outlets 54 the same; and arranging each first branch conduit 55a to be in fluid communication with a respective one of the first helium gas outlets 54.

Respective sizes of the first helium gas inlet 52, the second helium gas outlet 54, and the first inner conduit 56 are selected to be within a range of not generating an arcing.

The second helium gas supply passage 60 comprises a second helium gas inlet 62 provided in a bottom center of the base 20; a plurality of helium gas outlets 64 provided in an upper part of the base 20 corresponding to a center part of the wafer 10; and a second inner conduit 66 provided branched from the second helium gas inlet 62. The second inner conduit 66 is offset from the first inner conduit 56, and connected to the second helium gas outlets 64.

The second inner conduit 66 is formed offset from the first inner conduit 56 to minimize a limit on positioning the second helium gas passage 60, and to thereby emit the helium gas to the center part 14 of the wafer 10 uniformly.

A position of the second helium gas inlet 62 is changeable if required, but it is preferable to be provided in a bottom center of the base 10 within a range of not interrupting the first helium gas inlet 52 to enhance a cooling efficiency of the wafer 10 by having the helium gas supplied to the edge part 12 and the center part 14 of the wafer 10 synchronously.

The plurality of second helium gas outlets 64 are provided along a circumference of the base 20 at regular intervals to emit the helium gas corresponding to the center part 14 of the wafer 10. The intervals may be varied as necessary.

The second inner conduit 66 may comprise a plurality of second branch conduits 65a connected to the second helium gas inlet 62, and a second circular conduit 65b connected to the second branch conduit 65a and the second helium gas outlets 64. Alternatively, in the second helium gas supply passage 60, the second inner conduit 66 may be formed omitting the second circular conduit 65b, making a number of the second branch conduits 65a and a number of second helium gas outlets 64 the same, and arranging each second branch conduit 65a to fluidly communicate with a respective one of the second helium gas outlets 64.

The first helium supply passage 50 and the second helium supply passage 60 are separately provided, thereby enabling the amount of the helium gas and a time the helium gas is supplied to the edge part 12 to be selectively controlled independently of an amount of the helium gas and the time the helium gas is supplied to the center part 14 of the wafer 10.

An operation condition of the ESC for a wafer described above with reference to FIGS. 3, 4 and 5 is as follows.

Helium gas is flowed in through the first helium gas inlet 52 of the first helium supply passage 50 which is provided in the base 20 and flows outwardly through the base 20 along the branched first inner conduit 56, and then emitted through the plurality of first helium gas outlets 54, thereby cooling the edge part 12 of the wafer 10 evenly. The helium gas emitted through the first helium gas outlet 54 flows between the first sealing member 30, the second sealing member 40, the base 20, and the wafer 10, when the wafer 10 is chucked on the base 20, therefore the helium gas can be intensively supplied to the edge part 12 of the wafer 10.

Likewise, helium gas is flowed through the second helium gas inlet 62 of the second helium supply passage 60 which is penetratingly provided in the base 20 and flows outwardly through the base 20 along the branched second inner conduit 66, and then emitted through the plurality of second helium gas outlets 64, thereby cooling the center part 14 of the wafer 10 uniformly. The helium gas emitted through the second helium gas outlets 64 stays inwardly of the second sealing member 40 when the wafer 10 is chucked on the base 20, thereby the helium gas may be intensively supplied to the center part 14 of the wafer 10.

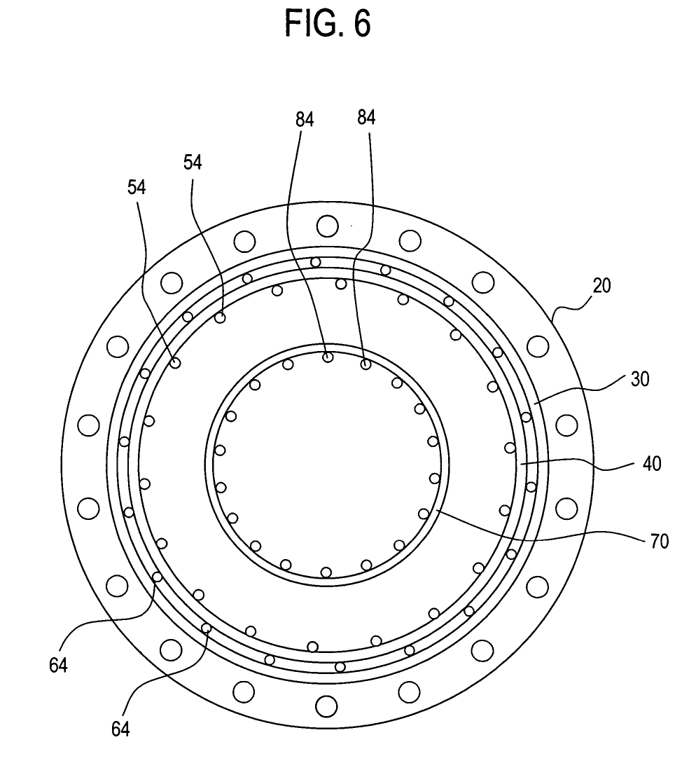

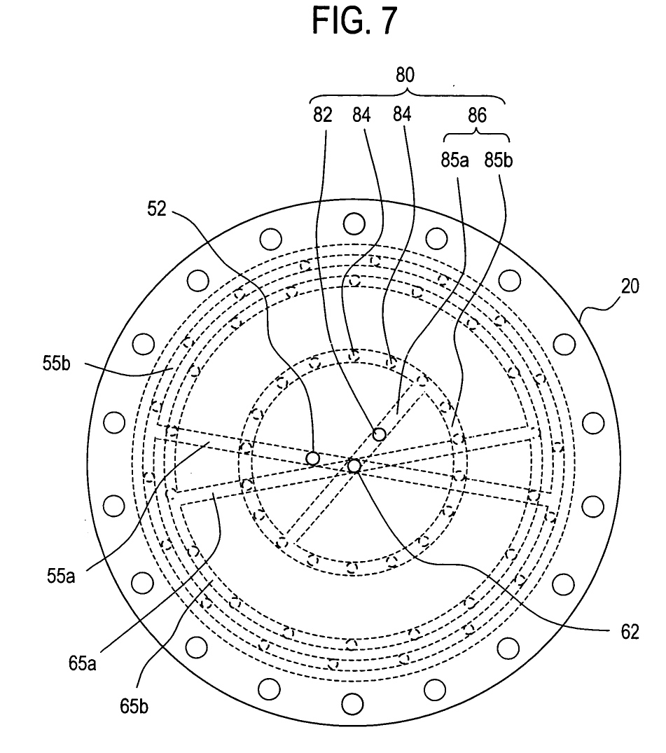

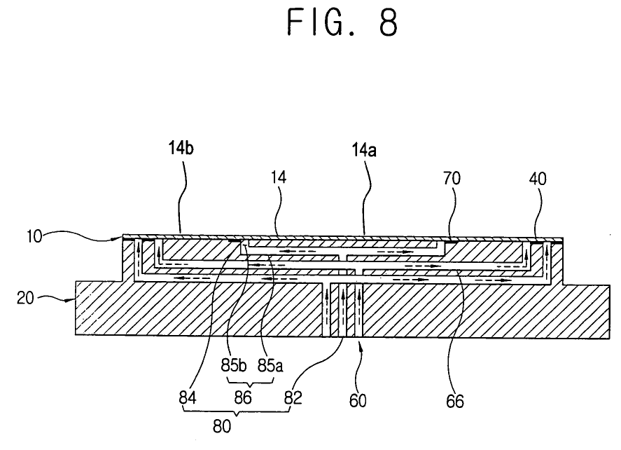

FIG. 6 is a top view illustrating an ESC for a wafer according to a second embodiment of the present invention, FIG. 7 is a bottom view illustrating a helium gas supply passage of the ESC for a wafer according to the second embodiment of the present invention, and FIG. 8 is a sectional view illustrating the ESC for a wafer in use according to the second embodiment of the present invention.

The second embodiment of the invention comprises the features illustrated in FIGS. 4, 5 and 6 and further comprises the additional features illustrated with respect to FIGS. 6, 7 and 8. In the description of the second embodiment, only the additional features will be discussed in order to avoid redundancy in the description.

As shown in FIGS. 6, 7 and 8, the center part 14 of the wafer 10 is further divided into a central part 14a and a surrounding part 14b to further enhance cooling efficiency. In the second embodiment, the ESC for a wafer further comprises a ring-type third sealing member 70 which divides the center part 14 of the wafer 10 into the central part 14a and the surrounding part 14b when the wafer is mounted; and a third helium supply passage 80 provided to be branched inside of the base 20 and offset from the first helium gas supply passage 50 and the second helium gas supply passage 60. The third helium supply passage 80 emits the helium gas to the central part 14a of the wafer 10.

The third helium gas supply passage 80 comprises a third helium gas inlet 82 provided at the bottom the base 20; a plurality of third helium gas outlets 84 provided in an upper part of the base 20 corresponding to the central part 14a of the wafer 10; a third inner conduit 86 provided branched from the third helium gas inlet 82 and offset from the second inner conduit 66, and connected to the third helium gas outlets 84.

The third inner conduit 86 may comprise a plurality of third branch conduits 85a, and a third circular conduit 85b connected to the third branch conduit 85a and the third helium gas outlets 84.

Descriptions and functions of the first sealing member 30, the second sealing member 40, the first helium gas supply passage 50 and the second helium gas supply passage 60 illustrated in FIGS. 6, 7 and 8 are the same in the descriptions and functions described with respect to FIGS. 3, 4 and 5 and further such descriptions and functions will be not be repeated in the description of the second embodiment.

In the second embodiment, the third sealing member 70 is added to an upper side of the base 20, a plurality of third sealing members 70 and corresponding helium supply passages may be provided, thereby cooling the center part 14 of the wafer 10 in segments.

With the above configuration, the present invention provides an ESC which decreases a temperature difference between an edge part and a center part of a wafer to improve the efficiency of cooling. Helium gas supply passages are provided in multiple layers to balance a time gap in supplying the helium gas, and to minimize a limit on positioning the helium gas supply passages.

Although a few embodiments of the present invention have been shown and described, it will be appreciated by those skilled in the art that changes may be made in these embodiments without departing from the principles and spirit of the invention, the scope of which is defined in the appended claims and their equivalents.

1. An electrostatic chuck (ESC) for a wafer comprising:
a base on which the wafer is mountable;
a first ring-type sealing member provided on an upper end part of the base;
a second ring-type sealing member separately provided on the upper end part of the base, and which divides the wafer into an edge part and a center part when the wafer is mounted;
a first helium gas supply passage formed inside the base, and which emits a helium gas to the edge part of the wafer; and
a second helium gas supply passage provided inside the base and offset from the first helium gas supply passage, and which emits the helium gas to the center part of the wafer.

2. The ESC for a wafer according to claim 1, wherein the first helium gas supply passage comprises:
a first helium gas inlet provided in a bottom of the base;
a plurality of first helium gas outlets provided in the upper end part of the base corresponding to the edge part of the wafer; and
a first inner conduit formed branched from the first helium gas inlet, and connected to the plurality of the first helium gas outlets.

3. The ESC for a wafer according to claim 2, wherein the first inner conduit comprises:
a plurality of first branch conduits connected to the first helium gas inlet; and
a first circular conduit connected to the plurality of the first branch conduits and the plurality of the first helium gas outlets.

4. The ESC for a wafer according to claim 2, wherein the second helium gas supply passage comprises:
a second helium gas inlet provided in a bottom of the base;
a plurality of second helium gas outlets provided in the upper end part of the base corresponding to the center part of the wafer; and
a second inner conduit formed branched from the second helium gas inlet, and connected to the plurality of second helium gas outlets.

5. The ESC for a wafer according to claim 4, wherein the second inner conduit comprises:
a plurality of second branch conduits connected to the second helium gas inlet; and
a second circular conduit connected to the plurality of the second branch conduits and the plurality of the second helium gas outlets.

6. The ESC for a wafer according to claim 3, wherein the second helium gas supply passage comprises:
a second helium gas inlet provided in a bottom of the base;
a plurality of second helium gas outlets provided in the upper end part of the base corresponding to the center part of the wafer; and
a second inner conduit formed branched from the second helium gas inlet, and connected to the plurality of the second helium gas outlets.

7. The ESC for a wafer according to claim 6, wherein the second inner conduit comprises:
a plurality of second branch conduits connected to the second helium gas inlet; and
a second circular conduit connected to the plurality of the second branch conduits and the plurality of the second helium gas outlets.

8. The ESC for a wafer according to claim 1, further comprising:
a third ring type sealing member provided on the upper end part of the base, and which divides the center part of the wafer into first and second areas when the wafer is mounted; and
a third helium gas supply passage provided inside the base and offset from the second helium gas supply passage, and which emits the helium gas to the first area of the divided center part of the wafer.

9. The ESC for a wafer according to claim 8, wherein the third helium gas supply passage comprises:
a helium gas inlet provided in the bottom of the base;
a plurality of helium gas outlets provided in the upper end part of the base corresponding to the first area of the divided center part of the wafer; and
an inner conduit formed branched from the helium gas inlet and connected to the plurality of the helium gas outlets.

10. The ESC for a wafer according to claim 9, wherein the inner conduit comprises:
a plurality of branch conduits connected to the helium gas inlet; and
a circular conduit connected to the plurality of the branch conduits and the the plurality of the helium gas outlets.

11. The ESC for a wafer according to claim 4, further comprising:
a third ring type sealing member provided on the upper end part of the base, and which divides the center part of the wafer into first and second areas when the wafer is mounted; and
a third helium gas supply passage provided inside the base and offset from the second helium gas supply passage, and which emits the helium gas to the first part of the divided center part of the wafer.

12. The ESC for a wafer according to claim 11, wherein the third helium gas supply passage comprises:
a third helium gas inlet provided in the bottom of the base;
a plurality of third helium gas outlets provided in the upper end part of the base corresponding to the first area of the divided center part of the wafer; and
a third inner conduit formed branched from the third helium gas inlet and offset from the second inner conduit, and connected to the plurality of the third helium gas outlets.

13. The ESC for a wafer according to claim 12, wherein the third inner conduit comprises:
a plurality of third branch conduits connected to the third helium gas inlet; and
a third circular conduit connected to the plurality of the third branch conduits and the plurality of the third helium gas outlets.

14. The ESC for a wafer according to claim 6, further comprising:
a third ring type sealing member provided on the upper end part of the base, and which divides the center part of the wafer into first and second areas when the wafer is mounted; and
a third helium gas supply passage provided inside the base and offset from the second helium gas supply passage, and which emits the helium gas to the first area of the divided center part of the wafer.

15. The ESC for a wafer according to claim 14, wherein the third helium gas supply passage comprises:
a third helium gas inlet provided in the bottom of the base;
a plurality of third helium gas outlets provided in the upper end part of the base corresponding to the first area of the divided center part; and
a third inner conduit formed branched from the third helium gas inlet and offset from the second inner conduit, and connected to the plurality of the third helium gas outlets.

16. The ESC for a wafer according to claim 15, wherein the third inner conduit comprises:
a plurality of third branch conduits connected to the third helium gas inlet; and
a third circular conduit connected to the plurality of the third branch conduits and the plurality of the third helium gas outlets.

17. An electrostatic chuck (ESC) for a wafer, comprising:
a body on which the wafer is mountable by electrostatic force, the body having first and second surfaces, oppositely disposed;
a plurality of sealing members mounted on the first surface and which divide the wafer into a plurality of predetermined areas when the wafer is mounted on the body;
a plurality of cooling gas outlets formed in the body and arranged in groups, each cooling gas outlet emitting a cooling gas onto the wafer, wherein outlets in a respective group emit the cooling gas onto the wafer in a respective predetermined area of the wafer;
a plurality of independent cooling gas inlets; and
a plurality of independent gas passages, each of which fluidly connects a respective cooling gas inlet with the cooling gas outlets in a group.

18. The ESC of claim 17, wherein:
each cooling gas inlet is positioned within central portion of the second surface; and
each independent gas passage comprises:
a first conduit which fluidly connects the cooling gas outlets in a respective group, and
a plurality of second conduits which fluidly connect the respective cooling gas inlet with the respective first conduit.

19. The ESC of claim 17, wherein:
each cooling gas inlet is positioned within central portion of the second surface; and
each independent gas passage comprises a plurality of conduits, each of which fluidly connects the respective cooling gas inlet with a respective one of the group of cooling gas outlets.

20. A method of cooling a wafer in an electrostatic chuck (ESC), the method comprising:
providing a body on which the wafer is mountable by electrostatic force;
providing seals which divide the wafer into a plurality of predetermined areas when the wafer is mounted on the body; and
introducing a cooling gas into each of the predetermined areas independently.

21. The method of claim 20, wherein the cooling gas is introduced into each cooling area synchronously with the introduction of the cooling gas into at least one other of the predetermined areas.
